(19) United States
(12) Patent Application Publication
(10) Pub. No.: US 2013/0317977 A1
(43) Pub. Date: Nov. 28, 2013

(54) System and Method for Managing Leases of Property

(71) Applicants: Joseph E. Lake, JR., Portland, OR (US); Dawn Holder, Omaha, NE (US); Andrew Lewis, Papillion, NE (US)

(72) Inventors: Joseph E. Lake, JR., Portland, OR (US); Dawn Holder, Omaha, NE (US); Andrew Lewis, Papillion, NE (US)

(73) Assignee: CSG Interactive Messaging, Omaha, NE (US)

(21) Appl. No.: 13/481,587

(22) Filed: May 25, 2012

(51) Int. Cl. G06Q 10/00; G06Q 40/00; G06F 15/16

(52) U.S. Cl. 705/39; 705/307

(57) ABSTRACT

An equipment recovery system receives data relating to leased property and associated lease accounts. The system provides lessees with interactive messages that enable them to make payments or payment commitments. Lessees may also make arrangements to return the property or surrender them to retrieval agents. Messages may be left for lessees, enabling them to contact the system or a call center to remedy delinquent payments or arrange return of the property. The system sends interactive messages to agents of lessors enabling them to: check delinquency or payment status; accept payments; make arrangements for the retrieval of the property; or report the outcome of a retrieval attempt. Contact between the system and either the lessee or the agent may be recorded and data received may be stored and reported.

### BACKGROUND

When lessees of property are at the point of defaulting on their lease agreements, lessors need to collect, or otherwise minimize the loss of, sums remaining due under the leases. Oftentimes, however, one or more pieces of leased property remain in the lessees' possession and needs to be returned. Such property may have a value that ranges widely, depending on the industry in which the lease is transacted. To be sure, a leased set-top cable box will have a significantly lower financial value than a leased automobile. However, the cumulative financial value of hundreds of thousands of set-top cable boxes, which may be lost to defaulting lessees, presents a very real financial concern for lessors. Accordingly, the return of leased property to a lessor or its agent is a significant component to the management of any lease, regardless of the industry or type of property that may be subject to the lease.

Lessors often use agents, such as contractors or third parties, to pursue final collections and property recovery efforts, with varying rates of success. A significant factor in low collections and equipment recovery rates is the difficulty in reliably contacting the lessors and making appointments for collections or equipment recovery. The value of any individual appointment successfully concluded may be quite high, in terms of the possibility of collecting a “salvage” payment as well offsetting recovery costs and the potential charge off value of the equipment recovered.

The current typical industry process in the television service provider industry is largely manual and focuses on points of contact during the account aging process, as follows

| | |
|---|---|
| Day 30 | Bill Mailed to Lessee |
| Day 45 | Late Payment Reminder Call to Lessee |
| Day 48 | Collection Notice Mailed to Lessee |
| Day 50 | Account Transitioned to Collections Agent |
| Day 50-53 | Field Collection Door Knock (door hanger) |
| Day 55 | Soft Disconnect |
| Day 56-58 | Second Field Collection Door Knock |
| Day 60-70 | Property Recovery Door Knock |
| Day 70 | Charge Off, Referred to Collections |

Such a process comes with a cost. As the process is largely done manually, labor costs are expended, primarily in the form of available labor and money. Where the labor comes from a third party contractor, such as a collections specialist, it is common to expend sums of one-third or more of any successful collections on the contractor's fees. Even where some tasks are maintained in-house with the lessor, such as mailing notices to the lessees, labor costs and expenditures add up in view of rising printing and postage costs. To be sure, though, a significant amount of valuable time is expended on such a process.

The expenditure of any amount of time and money in such a manual system is no guarantee of success. To be sure, the very nature of the process is “hit and miss” as the lessor or its agents attempt to contact lessees. When sending lessors or lessor agents on door-to-door “cold calls” on delinquent lessees, there is no accurate predictive model to determine the likelihood that the lessees will be available at the time that contact is attempted. There is also the realization that a number of lessees who are delinquent on their leases will intentionally avoid the lessors or lessor agents.

Moreover, manual labor-based lease management systems do not provide accurate, real-time reporting of statistical data. Most manual labor-based systems involve the manual tabulation of data that is oftentimes stored in a filing cabinet and never used for more than a permanent record of a single event. Such systems do not provide valuable feedback on data calculations such as: collection rates; times and methods of successful lessee contacts; and lease delinquency comparisons between different types of leased properties.

The lack of reporting and data management associated with manual labor-based lease management further prevents such systems from being nimble. To be sure, such systems are not able to provide in-field updates to lessors or lessor agents, who need confirmation of lessee reports of prior payment or property return. Manual-labor-based systems do not provide the lessor client with the option of “zoning” its field labor force for in-person contact by lessors or lessor agents who are geographically near lessees who want to surrender a salvage payment or the property itself. As such, needless return trips, which crisscross large geographic areas by lessors or lessor agents, inefficiently expends valuable time and money.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

A system for managing leases of property is provided, in various embodiments, to assist in the return or retrieval of leased property and the collection of debts associated with the lease agreements. In various embodiments, the system includes a central server, having a processing unit, a data storage medium, and access to a communications network, such as the Internet or a publicly switched telephone network (PSTN). The system is provided with lease data, which, in many embodiments, includes contact information for lessees, information relating to lease property in their possession, and debts owed pursuant to the terms of the lease agreements. Software associated with the system receives the lease data and filters it to identify the group or groups of lessors that should be contacted according to predefined parameters. In various embodiments, the system places calls to the lessors within the identified groups. Similarly, software is provided to receiving information relating to the lessors and their agents. The software filters the information to determine the group or groups of lessors and lessor agents that should be contacted according to predefined parameters. In some embodiments, the system places calls to each of the lessors or lessor agents within the groups. In other embodiments, the system is provided to receive inbound calls from lessors or lessor agents to retrieve aspects of lease data or to provide updates to lease data maintained on the system.

In some embodiments, the system asks the individuals who answer the system's calls to the groups of lessees to verify if they are the primary or secondary party responsible for the lease and if they are responsible for the debt. In some embodiments, when no response is received, or the individual responds that neither the primary nor the secondary party are available, a message may be left that leaves contact information to enable lessees to call the system at a later time. In various embodiments, where it is confirmed that a lessee has answered the call, the system may query the lessees to see if an automatic payment can be made at that time. Where an automatic payment is not made, the system may ask to schedule a payment at a particular future date. Where desirable, the system may connect the lessees with a customer service representative to assist with more complex account or payment issues. In various embodiments, where no payment will be made, the system may schedule a date by which the lessee will return the leased property at a specific location. In some embodiments, where the lessee does not agree to return the leased property, the system may schedule a date and time when the lessor or lessor agent may come to retrieve the leased property from the lessee.

In various embodiments, the system receives contact from lessors or lessor agents. The system may query the lessors or lessor agents to confirm that he or she is the designated party responsible for pursuing the lease account. In some embodiments, the system may query whether the contact is to: confirm job status; perform job updates; handle payment processing; or process equipment returns. Where the system is unable to reach the lessor or lessor agent directly, the system may leave a message for the lessor or lessor agent. It is also contemplated that lessor or lessor agent may call to correct certain contact or account information or report other issues that are more complex than reporting job disposition, processing a remittance or reporting the retrieval of property or equipment. In such an instance, the system may transfer the call to a live representative.

In various embodiments, the system records contact between the system and the lessors, lessor agents, or lessees. In some embodiments, the system also records contact results. The information may be provided to lessor clients in a real-time manner using a network connection between a lessor computer device and the system. Such reports may provide valuable screening information to the client, including habitual low-probability of response lessees and the screening of delinquent lessee contact information.

Some embodiments of the system provide lessors or lessor agents with interactive messages that enable the lessors or lessor agents to monitor various aspect of leases, including: verification of payment status; check delinquency status; accept payments from lessees; make arrangements for the retrieval of the leased property; or to report the outcome of an attempt to retrieve the leased property. Embodiments of the system may transfer the lessors or lessor agents to one of various customer service representatives when necessary. In some embodiments, the system may be provided with detailed property information such as serial numbers and the like, to enable lessors or lessor agents to accurately retrieve particular property in the field, as well as report the retrieval once completed.

Various embodiments of the present technology record the contacts between the system and the lessees as well as the contacts between the system and the lessors or lessor agents. The recorded data may be provided to lessor clients in real-time using a network connection between a client computer device and the system. The system provides reports using various aspects of the contact data to provide valuable screening information to the lessor client, including: work performance of lessors or lessor agents; success rates in retrieving property; and success rates in collecting delinquent debts.

These and other aspects of the present system and method will be apparent after consideration of the Detailed Description and Figures herein.

### DRAWINGS

Non-limiting and non-exhaustive embodiments of the present invention, including the preferred embodiment, arc described with reference to the following figures, wherein like reference numerals refer to like parts throughout the various views unless otherwise specified.

FIG. 1 depicts a general system schematic of a computer device that may be used with the present systems and methods for managing leases of property.

FIG. 2 depicts a general system schematic of one embodiment of a system that may be used to manage the lease of various types of property.

FIGS. 3a, 3b, and 3c depict an exemplary outbound process and call flow for consumer facing transactions.

FIG. 4 depicts a portion of an exemplary outbound call flow for consumer facing transactions.

FIG. 5 depicts an exemplary process and call flow for inbound contact from lessors or lessor agents.

FIG. 6 depicts a portion of a process and call flow for inbound calls for lessor or lessor agent transactions.

FIG. 7 depicts an exemplary embodiment of a system report of primary calling activity.

FIG. 8 depicts an exemplary embodiment of a system report that details calls by lessors or lessor agents.

FIG. 9 depicts an exemplary embodiment of a system report summarizing application activity by lessors or lessor agents.

FIG. 10 depicts an exemplary embodiment of a system report regarding lease payments that have been collected.

FIG. 11 depicts an exemplary embodiment of a system report of leased equipment retrieved.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

The present technology introduces systems and methods for managing leases. In various embodiments, an automated system contacts lessees of property or services in order to facilitate return or retrieval of the leased property and/or to collect debt owed in connection with the lease. Embodiments of the systems and methods also enable lessors and lessor agents to contact an automated system, or live agent when desired, in the course of managing such leases or collecting debts or property pursuant to such leases. Accordingly, one or more exemplary embodiments of the present technology refer to “leases” and “leased property.” These are not to be construed as limiting terms but are to be construed generically. For example, a “lease”, as that term is used herein describes, broadly, a body of legal arrangements between two or more parties for one or more services, which may include the use of one or more pieces of property for which ownership of the property is not transferred within the legal arrangement. Accordingly, the legal arrangement may be equally construed as a services agreement, rental agreement, lease, or one of various legal derivations of such terms. In one embodiment, the lease may focus on a cable or satellite television contract to provide television services to a residence or commercial location. In such instances, the provision of one or more electronic signals provides at least a part of a service, which may be supported by property such as a set-top box, signal receiving equipment, and the like. In another example, the lease may focus on the lease of an automobile to one or more individuals or organizations. In such an example, the legal arrangement focuses on the service of temporarily providing the lessee with the use of an automobile and any ancillary property. Accordingly, “leased property” may involve any tangible and intangible property that may be the subject of a “lease.”

Exemplary embodiments of the present technology refer to the term “lessor.” This term is to be construed broadly to mean a provider of one or more services and/or articles of “leased property,” which may or may not be owned by the lessor, to a “lease.” The term “lessor” may frequently be used interchangeably with “client” as many embodiments of the system 10 will be designed for servicing lessor clients requiring lease management to some degree. Similarly, the term “lessor agent” may be construed herein to refer to a party having a legal relationship to the lessor on the lessor-side of the “lease.” For example, in some embodiments, the lessor agent may be an employee of the lessor. In other embodiments, the lessor agent may be a third party or contractor with a contractual relationship with the lessor or a party common to the lessor. Non-limiting examples of lessor agents include individuals or organizations participating in: debt and/or property collections; party to party communications; information and data acquisition and/or reporting; billing services; property maintenance; customer service; and the like. The individual terms “lessor” and “lessor agent” are to be understood to encompass and provide support for claims that recite simply to “lessors” or “lessors or lessor agents” as it is contemplated that various embodiments of the present system and method may involve a lessor that performs all of the lessor-side duties relating to a lease, whereas some embodiments may involve a lessor and one or more lessor agents who perform one or more discrete lessor-side duties. To be sure, in some instances, lessor agents will provide a vast majority of the duties and interaction with the lessees.

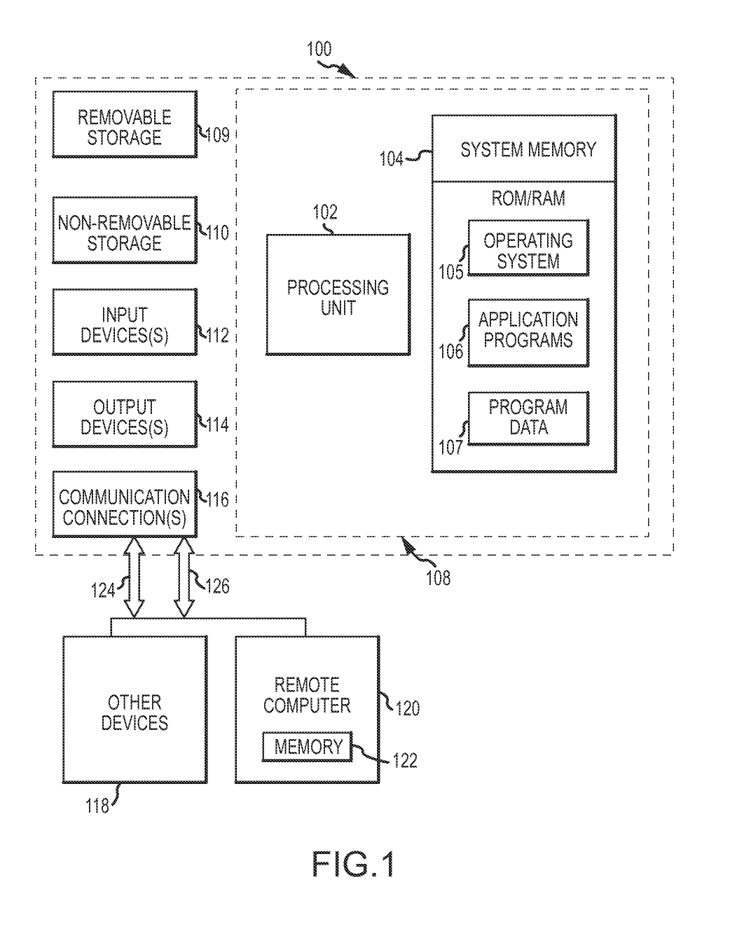

With reference to FIG. 1, an example of a suitable computing system environment is illustrated in the form of a computing device 100 on which one or more various embodiments of a lease management system 10 may be at least partially implemented. The computing device 100 is only one example of a suitable computing environment and is not intended to suggest any limitation as to the scope of use or functionality of the present system. The system 10 can also be run on other general purpose or special purpose computing system environments or configurations. Examples of well known computing systems, environments, and/or configurations that may be utilized include, but are not limited to, personal computers, server computers, network PCs, minicomputers, mainframe computers, distributed computing environments that include any of the above systems or devices, and the like.

The system 10 may be described in the general context of computer-executable instructions, such as program modules, being executed by a computing device. Generally, program modules include routines, programs, objects, components, data structures, etc. that perform particular tasks or implement particular abstract data types. The system 10 may also be practiced in distributed computing environments in which tasks are performed by remote processing devices that are linked through a communications network. In a distributed computing environment, program modules may be located in both local and remote computer storage media, including memory storage devices.

Computing device 100, in a generic configuration, typically includes at least one processing unit 102 and system memory 104. Depending on the exact configuration and type of computing device, system memory 104 may be one of various forms of computer readable media and/or data storage media, including volatile (such as RAM), non-volatile (such as ROM, flash memory, and the like) or some combination of the two. System memory 104 typically includes various forms and compilations of software, such as: an operating system 105; application software 106; and may include program data 107. Non-limiting examples of application software 106 include interactive voice response (IVR) programs, phone dialer programs, dual-tone multi-frequency (DTMF) recognition programs, speech recognition programs, text-to-speech programs, e-mail programs, SMS programs, external interface programs, scheduling programs, PIM (personal information management) programs, database programs, word processing programs, spreadsheet programs, Internet browser programs, and so forth. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, CD-RW, DVD, or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art and need not be discussed at length here.

Computing device 100 also contains communication capability 116 that allows the device to communicate with other devices 118 (such as printing devices, stand alone e-mail servers, facsimile devices, and the like), such as over a network or a wireless mesh network. Communication media can be transmitted through the communication capability 116 and can include computer readable instructions, data structures, program modules or other data in a modulated data signal such as a carrier wave or other transport mechanism.

The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, or other wireless media. The term computer readable media, as used herein, includes both storage media and communication media.

The computing device 100 may operate in a networked environment using logical connections to one or more remote computers, such as a remote computer 120. The remote computer 120 may be operated by a client such as one or more lessors or lessor agents, one or more lessees, consumers or third-party service providers (including one or more providers of various information databases, research tools, reporting services, and the like); may take the form of a personal computer, a server, a router, a network PC, PDA, a peer device, or other common network node; and typically includes many or all of the elements described above relative to the computing device 100. It is further contemplated, however, that the remote computer 120 could be provided in the form of a telephone, which includes cellular telephones, landline telephones and the like. The logical connections, depicted in FIG. 1, include communications networks such as a local area network (LAN) 124 and a wide area network (WAN) 126, but may also include other proprietary and non-proprietary communications networks 128, such as wireless networks, a PSTN, the Internet, an intranet, extranet, and the like. It will be appreciated, however, that the network connections shown are exemplary and other networking and communication means may be used. FIG. 1 illustrates an example of a suitable system environment on which the present technology may be implemented.

In some embodiments, the computing device 100 may be configured to serve as a telephony server. In such embodiments, the computing device 100 may be coupled with communications networks 128 that may include one or more of the PSTN, VoIP network, TCP/IP network, or the like. The computing device may be configured to operate as an interpreter, or gateway, so incoming communications can interface with IVR programs and access information on one or more local or remotely situated databases containing real-time information that can be accessed by the IVR programs. In various embodiments, one or more databases may be linked to the computing device 100 over the TCP/IP network. One or more different applications may be associated with the computing device 100 that include: customer service applications, outbound calling applications, voice-to-text transcription applications, and the like. Some or all of these applications may be provided in VXML. As such, the computing device 100 may also contain one or more programs that control functions like text-to-speech, voice recognition and DTMF recognition.

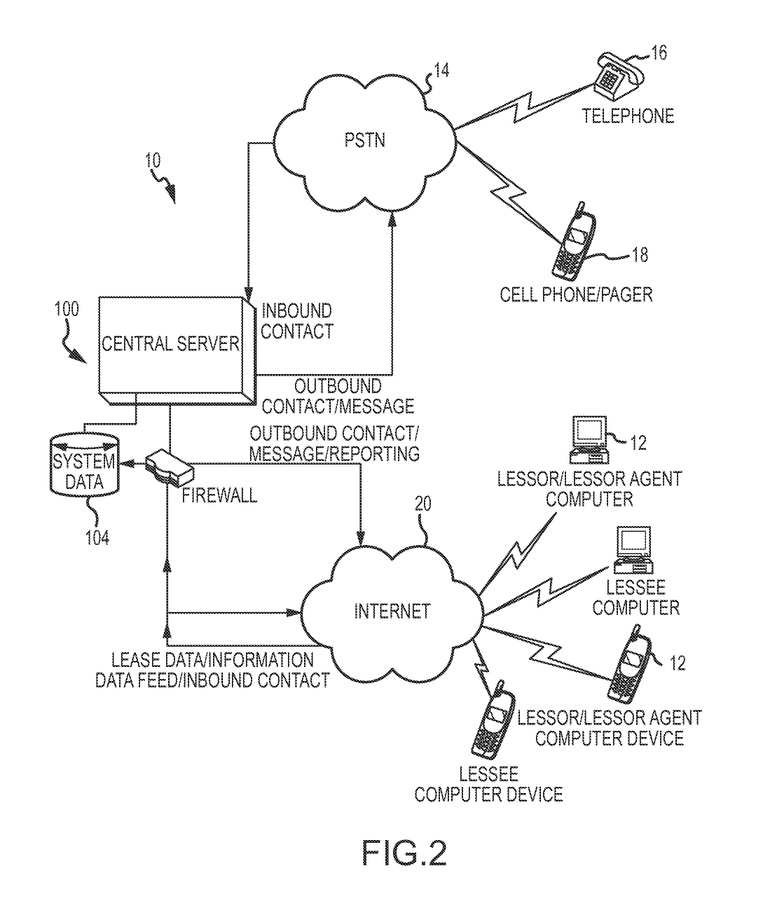

With reference to FIG. 2, a general system schematic is depicted of one embodiment of the system 10. In general terms, the system 10 includes a client (such as a lessor or lessor agent) system 12, which may be considered to be a subset of the remote computer 120, discussed previously. In some embodiments, the client system 12 may be operated by an automated or live call center agent. The client system 12, in various embodiments, may also include a client or third-party hosted IVR solution. In some embodiments, the client system 12 may include one or more computing systems, environments, and/or configurations that could include one or more of: server computers; network PCs; minicomputers; mainframe computers; personal computers, and the like. In other embodiments, the client system 12 may include a telephone, cell phone, wireless computing device, or similar communications device that is capable of accessing at least one network, such as a wireless network, PSTN 14, VoIP, the Internet 20, an intranet, extranet, and the like. It will be appreciated , however, that the client system 12 and the networks described are exemplary and other devices and networks may be used. The client system 12, in most respects, will be configured to selectively transmit and receive data streams. These data streams may be in the form of voice, text, or other such transmissions. A connection over communications network 128 may be provided to enable the exchange of data streams between the client system 12 and the computing device 100.

One or more various iterations of application software 106 may be provided to operate on the processing unit 102. The application software 106 enables the computing device 100 to receive lease data, including but not limited to: lease information (including but not limited to the terms of one or more leases, notes relating to particular aspects of one or more specific leases or occurrences or events relative thereto); contact information for lessees, lessors, and lessor agents; information relating to leased property in the possession of the lessees and debt owed by the lessees. Lease data may be transmitted from a client system 12 such as one or more lessor personal computers, laptops, tablet computers, smartphones, host systems, and the like, operated by a lessor or lessor agent over a communications network to which the computing device 100 is coupled. It is contemplated that the lease data could also be forwarded to the computing device 100 by mailing or delivering data storage media, such as diskettes, CDs, DVDs or flash memory devices, that are readable by the computing device 100 or a separate workstation coupled with the computing device 100.

In various embodiments, the system 10 receives a set of pre-defined criteria that is used to “filter” or “pre-screen” the lease data received from the client system 12. Application software 106 may be provided to select one or more particular groups of lessees to be contacted by the system 10. Similarly, the application software 106 may be provided to select one or more lessor or lessor agents to be contacted by the system 10. The portions of the lease data not selected by the application software 106 may simply be stored for future use, or when directed by the client, purged from the system 10. Some examples of pre-defined criteria may include: a length of time (set as a threshold or range) that a debt associated with a lease has been due and/or delinquent; a value of property (set as a threshold or range) still in the lessee's possession; or any violation of lease terms or related agreement between the lessor and lessee. It is also contemplated that the system 10 could be used for maintenance, upgrade, or replacement of lease property. In such instances, the predefined criteria might include: types of lease property recall; availability of upgrade lease property; or other notices (including manufacturer notices) or data relative to the leased property. The type of pre-defined criteria is nearly limitless and can be used to custom tailor a property recovery or retrieval campaign, or delinquent debt collections campaign, according to the client's needs. The criteria may also be modified as the campaigns progress, depending on the results achieved by the system 10 using criteria initially provided by the clients. The use of such a filter will further focus the lessors or lessor agent's resources used and provide a greater efficiency to the system 10 as a whole.

The system 10 accesses a communications network to contact, or receive contact from, each lessee, lessor, or lessors agent. FIG. 2 depicts an exemplary embodiment where the communications network is a PSTN and the computing device 100 is programmed to contact each lessee, lessor, or lessors agent, using a telephone 16 or other communications device 18, such as a cell phone, paging device or PDA, belonging to a lessee, lessor, or lessors agent. It is also contemplated that the lessee, lessor, or lessors agent, can be contacted over the Internet or via cell phone text messaging, a/k/a Short Messaging Service (SMS). In the example depicted, the system 10 places an outbound call using the contact information of the lessee. The application software 106 is operative to wait for the line to go off the hook, wherein an audible (or visual, depending upon the application device being contacted) greeting, such as, “This is First Prairie Home Entertainment calling with important information about your account.” In various embodiments, the application software 106 is operative to receive a response from the applicant in the form of DTMF tones, speech, or other formats of data transmission, identify the format of the transmission, and respond in an appropriate format. Accordingly, it is contemplated that various forms of text-to-speech, speech recognition and DTMF tone recognition applications may be incorporated with the application software 106. However, for the purposes of simplicity only, the examples of contact between the system 10 and the lessee, lessor, or lessors agent, will be described herein as using DTMF tone recognition and certain text-to-speech protocols.

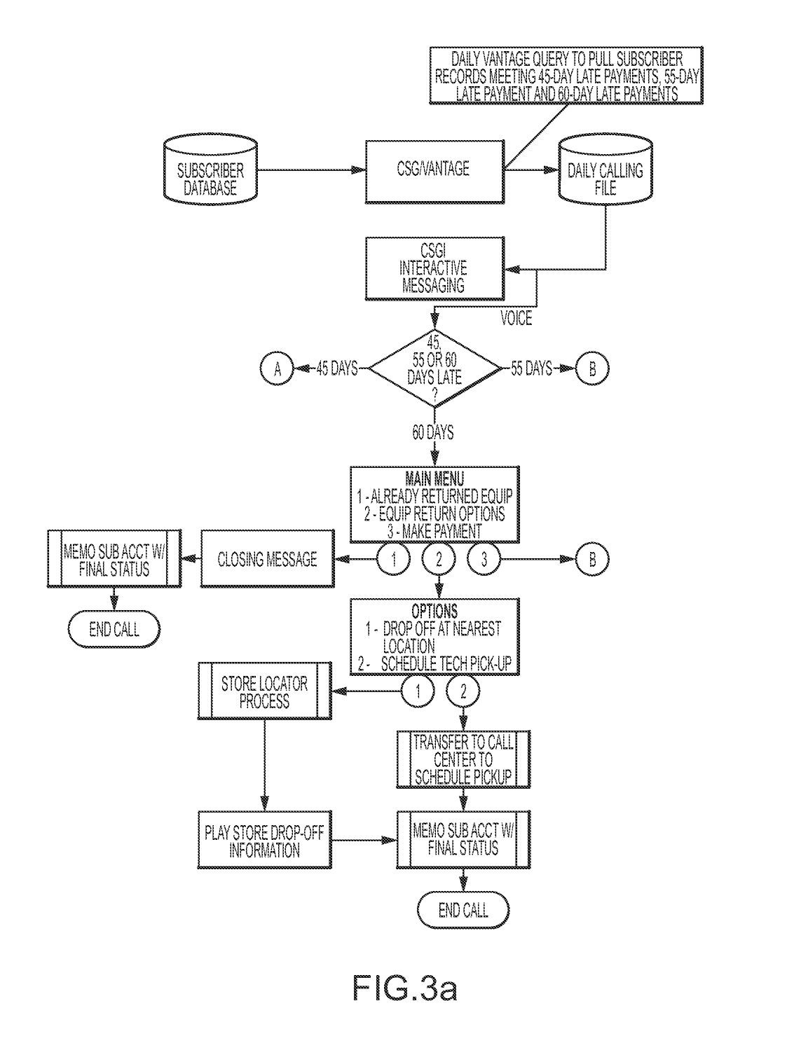

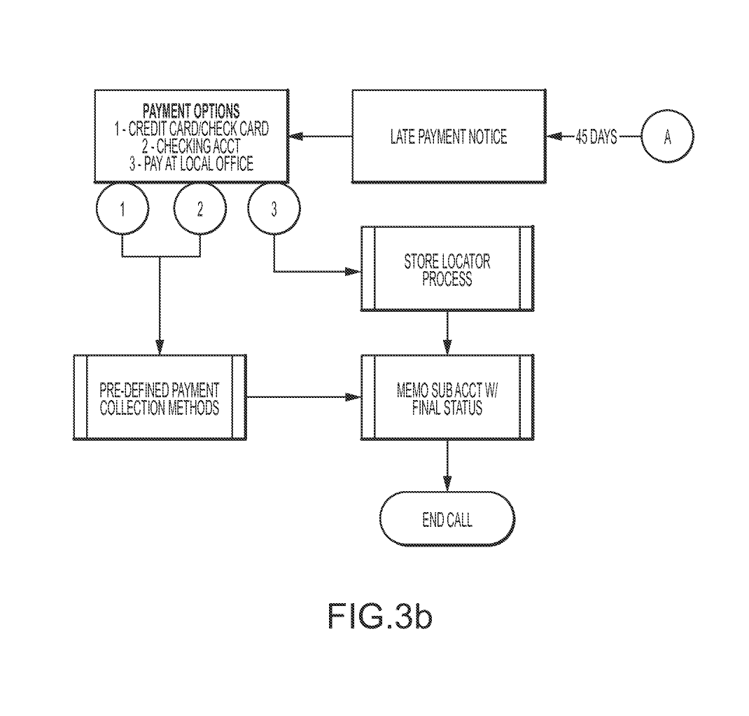

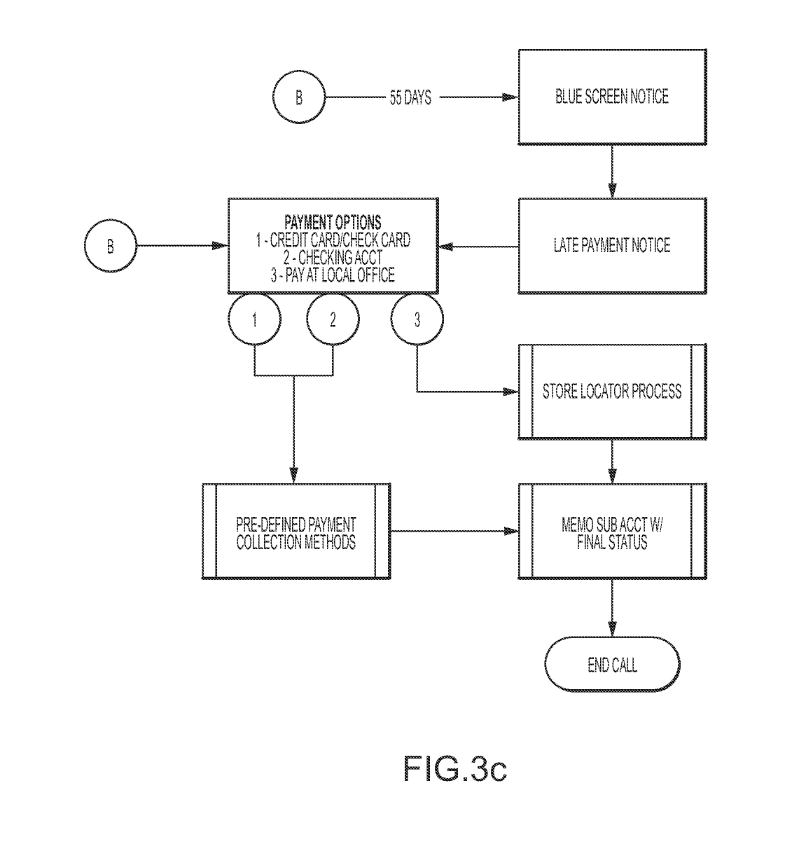

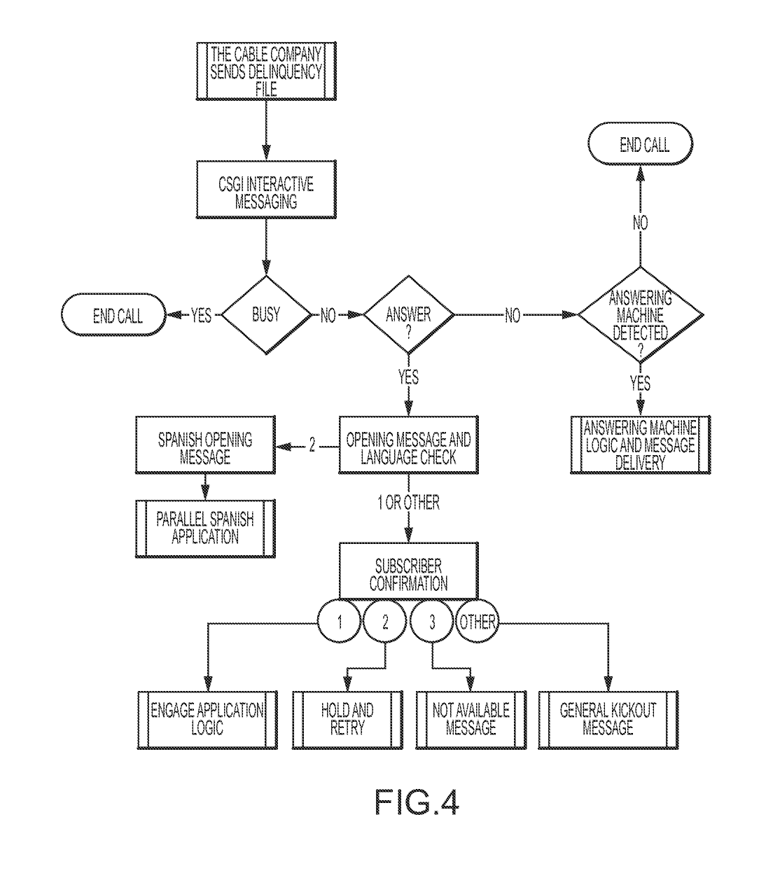

With reference to FIGS. 3a, 3b, 3c, and 4, exemplary embodiments of outbound processes and call flows for consumer facing transactions are depicted. In some embodiments, the system 10 may ask, “If this is John Doe, please press one, or if this is Jane Doe, please press two. If neither John nor Jane Doe are available, press three.” The application software 106 will be provided to recognize such specific responses and proceed accordingly. Where no response is received by the system 10, or an input other than those offered by the system 10 is detected, the system 10 may reply, “I am sorry. That is not a valid selection.” After a predetermined number of retries, the system 10 can simply terminate the call, stating, “We look forward to serving you in the future. Thank you.” Where the number 3 is selected in this particular example, the system 10 may provide a message such as, “Please ask John Doe to call us back at 1-800-888-3151. Thank you.”

In other embodiments, where the lessee responds that he or she is the primary or secondary named party responsible for the account, the application software 106 may be provided to present an identity question to the lessee, using information provided by the client that is unique to the lessee. In that example, the system 10 may ask the lessee to simply enter the last four digits of the lessee's social security number. The application software 106 will receive the lessee's response and verify the response with the data received from the client. Where the system 10 determines that the response does not match the data, the application software 106 requeries the lessee. Where continued incorrect responses are received by the system 10, the call may be terminated. However, where a correct response is received by the system 10, the system 10 will continue forward through a predetermined call flow.

In the present example, the system 10 may advise the lessee that the call is being recorded and state, “Your home entertainment account is $193 past due, and your home entertainment lease agreement is now subject to immediate termination.” A countless number of script variations are contemplated. For example, the client may prefer that no data fields be provided relating to specific debt amounts or the name of the debt holder. The system may request that a payment be made or advise that a lessor or lessor agent wishes to make an appointment to retrieve the rented or leased property or equipment. The system may continue with the call, prompting, “To make an automated payment right now by telephone in order to restore your account to good standing, press 1. To schedule an appointment to have your equipment picked up by a field services agent, press two. To hear this message again, press the star key.”

If the lessee selects the number 1, the system may advise the lessee that, “We are getting ready to transfer you to the First Prairie Home Entertainment automated payment system. In order to process your payment, you must have your account number ready. If you have your account number ready, press 1. If you would like to pay, but need a moment to locate your account number, press 2. If this is not a convenient time for you and you'd like us to call back, please press 3.” The application software 106 will await the response from the lessee and respond accordingly. For example, if the lessee wishes to pay by phone and selects the number 1, the system may advise the lessee that a payment may be made from the lessee's checking or savings account to pay the existing debt or a portion thereof. In some embodiments, the system will then ask the lessee to enter the nine-digit bank routing number for the lessee's bank, followed by the pound key. The system may confirm the account number information received from the lessee by repeating the routing number received by the system 10, using a text-to-speech response. The system 10 will then typically ask the lessee to provide a specific response, such as entering the number 2, if the information is correct. The lessee is then asked to enter their account number, which is then verified by the system 10. The system 10 may then ask the lessee to press the number 1 if the account is a checking account and press 2 if the account is a savings account. Thereafter, the system 10 will ask the lessee to enter the payment amount, which will then be verified with the lessee. Once the payment is verified, the system simply thanks the lessee and terminates the call.

In another example, if the lessee wishes to pay by phone and selects the number 1, the system may advise the lessee that a payment may be made with the lessee's credit or debit card to pay the existing debt or a portion thereof. In some embodiments, the system will then ask the lessee to enter the complete account number for the lessee's credit or debit card, followed by the pound key. The system may confirm the credit or debit card number information received from the lessee by repeating the credit or debit card number received by the system 10, using a text-to-speech response. The system 10 will then typically ask the lessee to provide a specific response, such as entering the number 2, if the information is correct. The lessee is then asked to enter their three-digit security code, which is then verified by the system 10. The system 10 may then ask the lessee to press the number 1 if the number is a credit card and press 2 if the number is a debit card. Thereafter, the system 10 will ask the lessee to enter the payment amount, which will then be verified with the lessee. Once the payment is verified, the system simply thanks the lessee and terminates the call.

Where, during the previous options menu, the lessee needs a moment, and selects the number 2, the system may simply advise the lessee to “press the 8 key when you are ready to continue.” Preferably the system 10 will repeat such a message every few seconds, with a time out of a minute or two. When the lessee selects the number 3 because it is not a convenient time, the system may simply advise the lessee to, “Please call us back at 1-800-888-3151 when you have your account number available. Thank you.” The system would then simply terminate the call.

Where, during the initial options menu, if the lessee selects the number 2, the system may advise the lessee that, “We are getting ready to transfer you to the First Prairie Home Entertainment automated appointment scheduling system. If you are ready to schedule a time for a field service technician to come to your home and retrieve your equipment, press 1. If this is not a convenient time for you and you'd like us to call back, please press 2.” The application software 106 will await the response from the lessee and respond accordingly. For example, if the lessee wishes to schedule an equipment retrieval appointment and selects the number 1, the system may advise the lessee of several dates wherein appointments are available. The system will then ask the lessee to enter a number corresponding to their preferred appointment date, followed by the pound key. The system may then offer several times on the preferred appointment, asking the lessee to enter a number corresponding to their preferred appointment time, followed by the pound key. In this preferred embodiment, the system will then confirm the appointment date and time received from the lessee by repeating the date and time received by the system 10, using a text-to-speech response. The system 10 will then typically ask the lessee to provide a specific response, such as entering the number 2, if the information is correct. Once the appointment is verified, the system simply thanks the lessee and terminates the call.

It is contemplated that the system 10 may be unable to reach the lessees directly. However, when the system 10 reaches an answering machine or voicemail account for the lessee, the application software 106 should be capable of leaving a message to the lessee. An example of one such message may state, “Hello, this is First Prairie Home Entertainment calling with important account information for John Doe or Jane Doe. Please call us back at 1-800-888-3151, that number is 1-800-888-3151. Thank you.” The system 10 should, therefore, be provided in a manner that is capable of receiving inbound calls from lessees. Typically, the system 10 will receive the inbound calls or other types of communication over a network, such as those described previously. However, when the lessees call the system 10, the software should be provided to present the lessees with remittance and scheduling options, similar to those discussed herein above. It is also contemplated that lessees may call to correct certain contact or account information or report other issues that are more complex than a simple remittance or scheduling an appointment for equipment retrieval. In such an instance, the system 10 should be provided with a means of simply transferring the call over a network to a live representative, previously designated by the client. The representative may be a third party collections or customer service department, an in-house representative with the client, or the like.

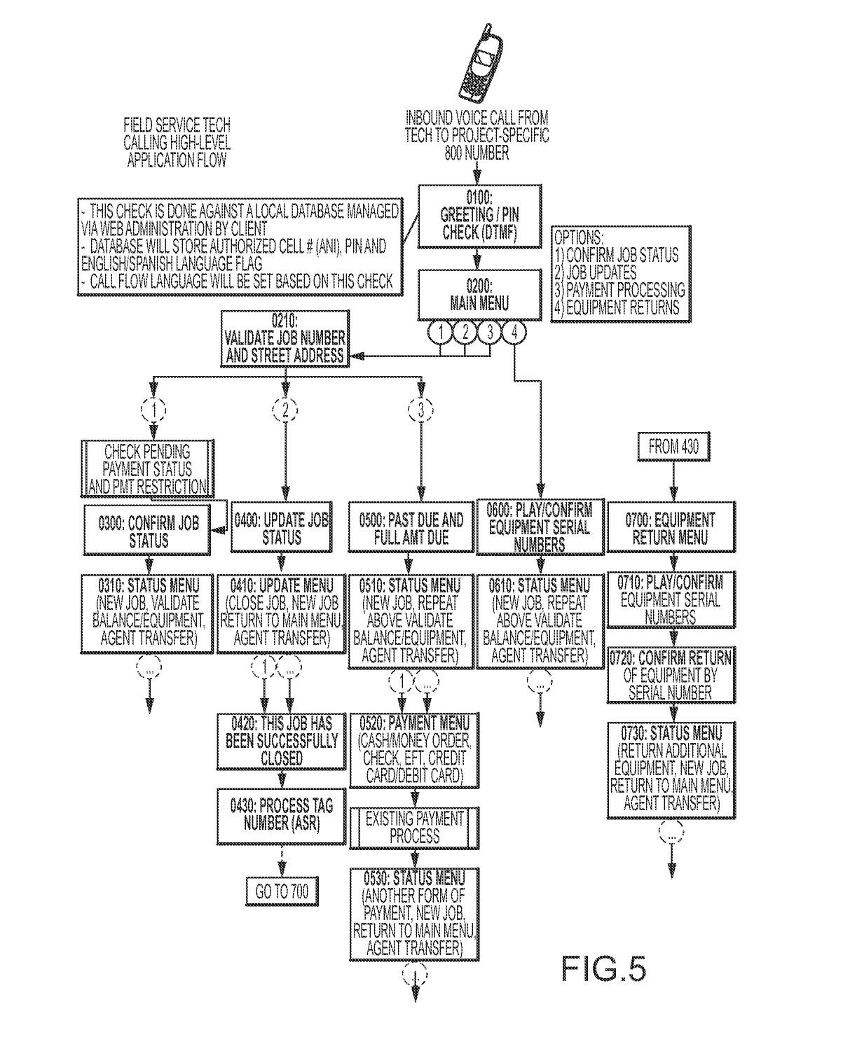

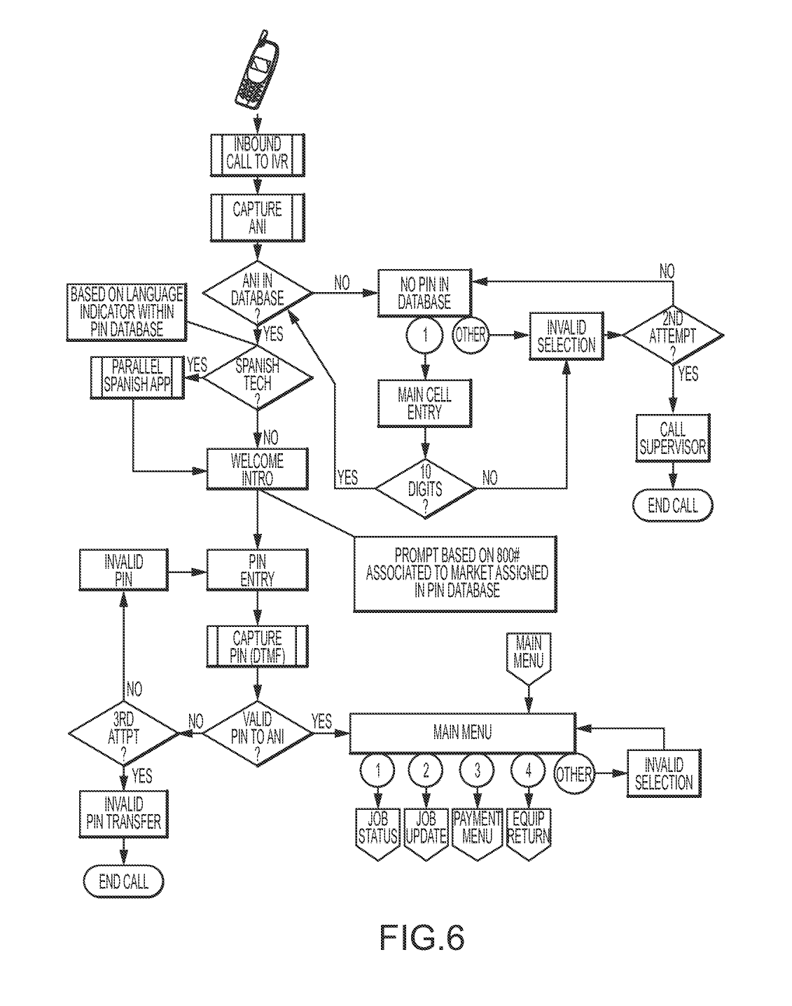

With reference to FIGS. 5 and 6, the system 10 may be provided to contact, or receive contact from, lessors or lessor agents regarding one or more leases and/or articles of lease property. Regardless of whether or not the system 10 initiates the contact, the system 10 may query the lessors or lessor agents to confirm their identity. Where the lessor or lessor agent responds that he or she is the designated party responsible for pursuing the account, the application software 106 may be provided to present an identity question to the lessor or lessor agent, using information provided by the client that is unique to that lessor or lessor agent. In that example, the system 10 may ask the lessor or lessor agent to simply enter a pre-defined personal identification number. The application software 106 will receive the lessor or lessor agent's response and verify the response with the data received from the client. Where the system 10 determines that the response does not match the data, the application software 106 requeries the lessor or lessor agent. Where continued incorrect responses are received by the system 10, the call may be terminated. However, where a correct response is received by the system 10, the system 10 will continue forward through a predetermined call flow.

In the present example, the system 10 may advise the lessor or lessor agent that the call is being recorded and query, “Press 1 to confirm job status, press 2 to perform job updates, press 3 to handle payment processing, or press 4 to process equipment returns.” A countless number of script variations are contemplated. For example, the client may prefer that certain data fields relating to property or equipment in the possession of lessees be suppressed or included. For example, in some embodiments, the system may be provided with detailed property information, such as property serial numbers and the like. This will enable lessors or lessor agents to accurately identify and retrieve particular property in the field. Once the property is retrieved, the detailed property information may be used to report to the system 10 that the retrieval has been completed.

If the lessor or lessor agent selects the number 1, the system 10 may retrieve additional data to advise the lessor or lessor agent of the status all delinquent account work orders assigned to them, for example, to inform the lessor or lessor agent that the lessees on a specific account have paid their outstanding balance through the customer service call center, and that the lessor or lessor agent no longer needs to travel to that address to make an attempt at debt collections or retrieval of property or equipment.

If the lessor or lessor agent selects the number 2, the system 10 may ask the lessor or lessor agent to input an account work order number, then offer another set of options concerning the disposition of that account, stating for example, “Press 1 to close this job, press 2 to update this job status.” Upon receiving further DTMF input from the lessor or lessor agent, the system 10 may then offer a series of job status codes to specify a reason the job has been closed, for example, due to successful collection of debt or successful retrieval of property or equipment as well as a series of job status codes to specify the reason the job is being updated, for example, that the lessee was not on the premises.

If the lessor or lessor agent selects the number 3, the system 10 may ask the lessor or lessor agent to input an account work order number, then offer a predetermined call flow for debt collections in the manner such as described above, except in this case, the lessor or lessor agent will also have the option of reporting to the system 10 the collection of the debt via paper check or cash in addition to automated payment via electronic transfer, credit or debit card.

If the lessor or lessor agent selects the number 4, the system 10 may ask the lessor or lessor agent to input an account work order number, then offer a predetermined call flow for reporting the retrieval of property or equipment associated with that account. The system 10 may retrieve additional data to provide the lessor or lessor agent with the physical description, model number or serial number, from which the lessor or lessor agent may select individual pieces of property or equipment to report a retrieval status.

It is contemplated that the system 10 may be unable to reach the lessor or lessor agent directly. However, when the system 10 reaches an answering machine or voicemail account for the lessor or lessor agent, the application software 106 should be capable of leaving a message to the lessor or lessor agent. An example of one such message may state, “Hello, this is First Prairie Home Entertainment calling with important job information for Richard Roc. Please call us back at 1-800-888-3151, that number is 1-800-888-3151. Thank you.” The system 10 should, therefore, be provided in a manner that is capable of receiving inbound calls from lessor or lessor agents. Typically, the system 10 will receive the inbound calls or other types of communication over a network, such as those described previously. However, when the lessor or lessor agent calls the system 10, the software should be provided to present the lessor or lessor agent with job disposition, payment or property and equipment retrieval reporting options, similar to those discussed herein above. It is also contemplated that lessor or lessor agent may call to correct certain contact or account information or report other issues that are more complex than reporting job disposition, processing a remittance or reporting the retrieval of property or equipment. In such an instance, the system 10 should be provided with a means of simply transferring the call over a network to a live representative, previously designated by the client. The representative may be a customer service department, an in-house representative with the client, or the like.

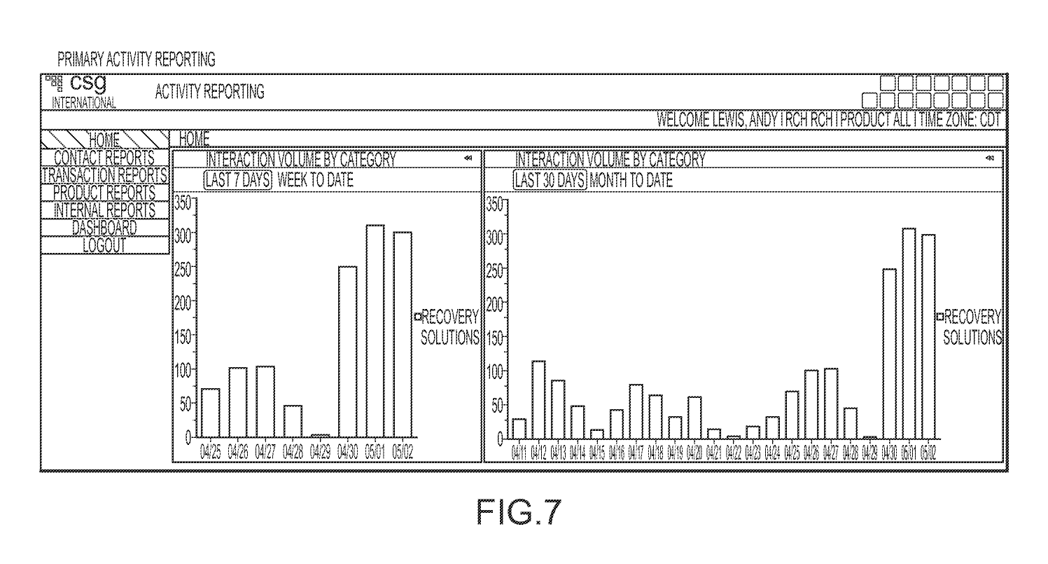

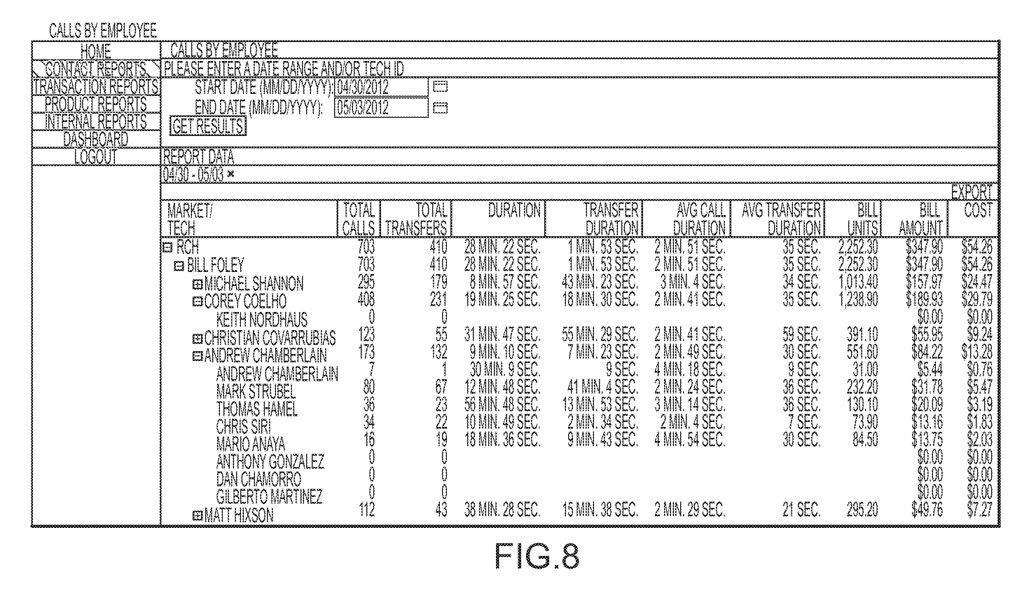

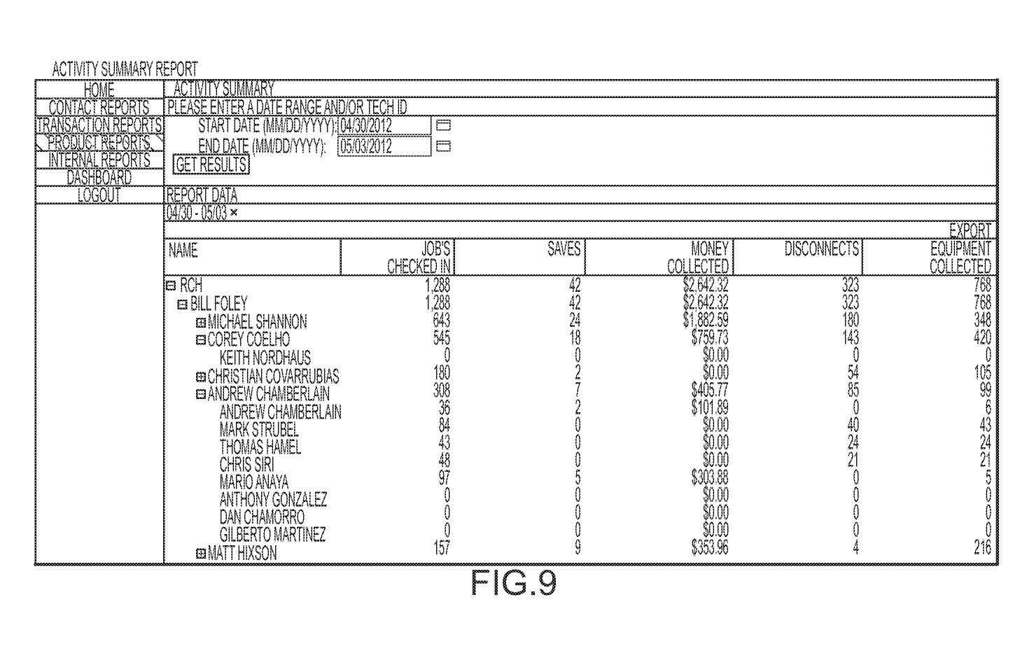

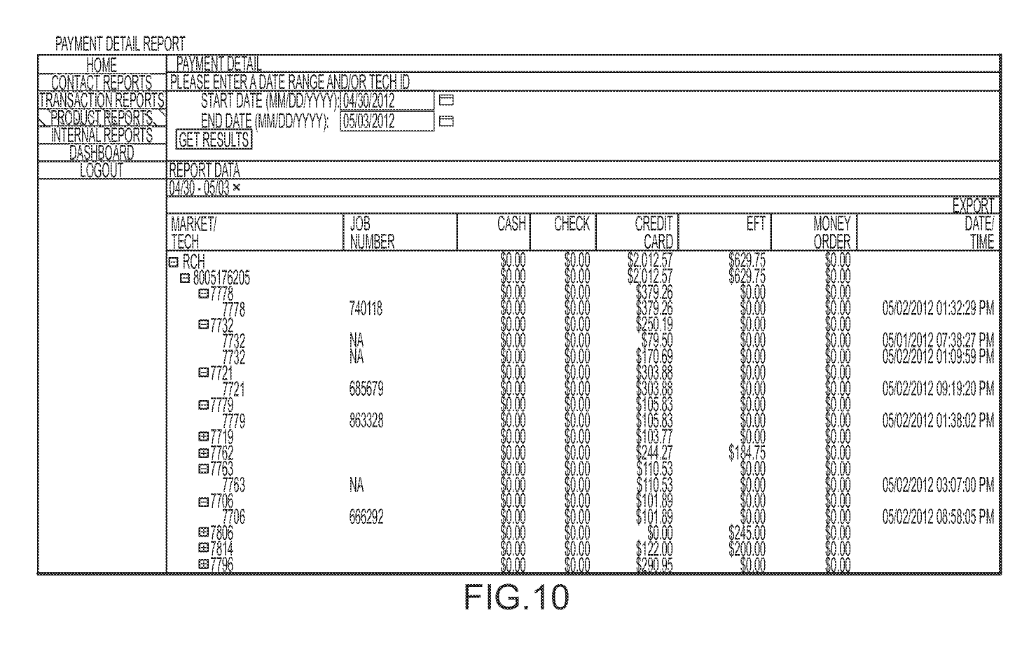

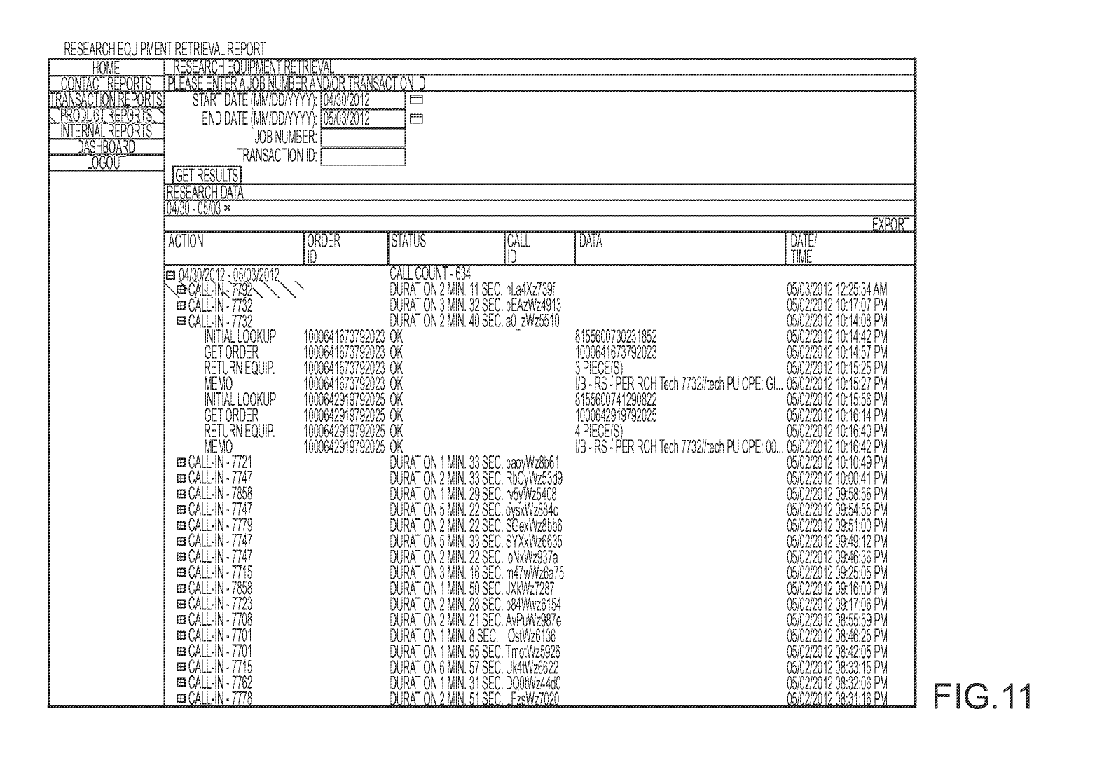

Data relating to the system's contacts with the lessees, or with the lessor or lessor agent, may be stored, at least temporarily, on the system memory 104. With reference to FIGS. 7-11, the application software 106 may be provided to formulate such data into individual reports to be provided to the clients. For example, FIG. 7 depicts an exemplary embodiment of a system report of primary calling activity. FIG. 8 depicts an exemplary embodiment of a system report relating to calls by lessors or lessor agents. FIG. 9 depicts an exemplary embodiment of a system report concerning application activity by lessors or lessor agents. FIG. 10 depicts an exemplary embodiment of a system report relating to collected lease payments. FIG. 11 depicts an exemplary embodiment of a system report of leased equipment that has been retrieved. Other standard and customized reports are contemplated that may be compiled and transmitted by the system 10.

It is also contemplated that the clients could be provided with access to such data and reports over the network to which the computing device 100 is connected, such as the Internet, a data link or the like. When desirable, the application software 106 may be provided to record the contact between the system 10 and the lessee, or the lessor or lessor agent, including questions and messages transmitted by the system 10 to such parties and any responses received thereto. These recordings may be stored on the system memory 104 along with time and date information relating to each recording. The system 10, in various embodiments, is capable of selectively replaying the recordings for the client and/or transmitting copies of the recordings to the clients, when necessary.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein.

What is claimed is:

1. A system for managing one or more leases and one or more articles of lease property between lessors and lessees, the system comprising:
a processing unit;
a data storage medium, operatively coupled with the processing unit, configured to at least temporarily store lease data associated with the one or more leases and one or more articles of lease property;
means for accessing a communications network operatively coupled with the processing unit; and
at least one computer readable medium operatively coupled with the processing unit and the data storage medium; the at least one computer readable medium comprising software configured to:
receive lease data that includes: (i) names and contact information for one or more lessees; (ii) information relating to lease property subject to the one or more leases; (iii) information relating to debt owed by the one or more lessees pursuant to terms of the one or more leases; and (iv) information relating to one or more lessors or lessor agents;
filter the lease data, according to pre-defined parameters, selecting lessees to be contacted;
initiate contact with selected lessees over the communications network;
query lessees about a return or retrieval of the lease property;
receive a response to the query from the lessees, over the network, and store lessee query responses on the data storage medium.

2. The system of claim 1 wherein the at least one computer readable medium further comprises software that operates on the processing unit and the data storage medium to:
confirm the lessees' identity, prior to querying the lessees about a return or retrieval of the property.

3. The system of claim 1 wherein the at least one computer readable medium further comprises software that operates on the processing unit to:
engage in contact with one or more lessors or lessor agents, associated with selected leases, over the communications network.

4. The system of claim 3 wherein the at least one computer readable medium further comprises software that operates on the processing unit to:
inform the one or more lessors or lessor agents about at least one of: (i) the location and payment status of the property; (ii) a remittance, or commitment for a future remittance, for the debt; (iii) a lessee commitment for the return of the property; and (iv) a lessee availability for the one or more lessors or lessor agents to retrieve the property.

5. The system of claim 4 wherein the at least one computer readable medium further comprises software that operates on the processing unit to:
query the one or more lessors or lessor agents about future actions to be taken by the system; and
receive a response to the query from the one or more lessors or lessor agents and store the response on the data storage medium.

6. The system of claim 4 wherein the, at least one computer readable medium further comprises software that operates on the processing unit to:
confirm an identity of the one or more lessors or lessor agents, prior to providing the one or more lessors or lessor agents with information.

7. The system of claim 1 wherein the at least one computer readable medium further comprises software that operates on the processing unit to:
put the lessees in communication with a customer service representative.

8. The system of claim 2 wherein the at least one computer readable medium further comprises software that operates on the processing unit to:
leave a message for the lessees when the system does not receive an affirmative response to the query regarding the identity of the lessees.

9. The system of claim 6 wherein the at least one computer readable medium further comprises software that operates on the processing unit to:
leave a message for the one or more lessors or lessor agents, when the system does not receive an affirmative response to the query regarding the identity of the one or more lessors or lessor agents.

10. The system of claim 1 wherein the at least one computer readable medium further comprises software that operates on the processing unit to:
receive a commitment for future remittance for the debt; and
schedule the future remittance with the lessee.

11. The system of claim 1 wherein the at least one computer readable medium further comprises software that operates on the processing unit to:
receive a remittance for the debt.

12. The system of claim 1 wherein the at least one computer readable medium further comprises software that operates on the processing unit to:
schedule a return of the property at a location associated with the one or more lessors or lessor agents.

13. The system of claim 1 wherein the at least one computer readable medium further comprises software that operates on the processing unit to:
schedule a retrieval of the property by the one or more lessors or lessor agents at a location associated with the lessees.

14. The system of claim 5 wherein the query of the one or more lessors or lessor agents includes:
offering the one or more lessors or lessor agents the option of collecting remittance toward the debts.

15. The system of claim 5 wherein the query of the one or more lessors or lessor agents includes:
offering the one or more lessors or lessor agents the option of reporting the retrieval of the property or equipment.

16. The system of claim 1 wherein the at least one computer readable medium further comprises software that operates on the processing unit to: record communications over the electronic network between the system and the lessees.

17. The system of claim 5 wherein the at least one computer readable medium further comprises software that operates on the processing unit to:
record communications over the electronic network between the system and the lessees and between the system and the one or more lessors or lessor agents.

18. The system of claim 17 wherein the at least one computer readable medium further comprises software that operates on the processing unit to:
prepare and transmit one or more reports regarding communications between the system and the lessees and between the system and the one or more lessors or lessor agents.

19. The system of claim 5 wherein the at least one computer readable medium further comprises software that operates on the processing unit to:
connect the lessees or the one or more lessors or lessor agents with a customer service representative over the communications network.

20. A method for managing one or more leases and one or more articles of lease property between lessors and lessees, the method comprising:
at least temporarily storing lease data associated with the one or more leases and one or more articles of lease property on a data storage medium that is operatively coupled with: (i) a processing unit; (ii) software stored on at least one computer readable medium; and (iii) a means for accessing a communications network; the lease data includes: (i) names and contact information for one or more lessees; (ii) information relating to lease property subject to the one or more leases; (iii) information relating to debt owed by the one or more lessees pursuant to terms of the one or more leases; and (iv) information relating to one or more lessors or lessor agents;
filtering the lease data with the software, according to pre-defined parameters, and selecting lessees to be contacted;
initiating contact with selected lessees over the communications network;
querying contacted lessees about a return or retrieval of the lease property; and
receiving a response to the query from the lessees, over the network, and storing lessee query responses on the data storage medium.

21. The method of claim 20 further comprising:
confirming the lessees' identity, prior to querying the lessees about a return or retrieval of the property.

22. The method of claim 20 further comprising:
engaging in contact with one or more lessors or lessor agents, associated with selected leases, over the communications network.

23. The method of claim 22 further comprising:
informing the one or more lessors or lessor agents about at least one of: (i) the location and payment status of the property; (ii) a remittance, or commitment for a future remittance, for the debt; (iii) a lessee commitment for the return of the property; and (iv) a lessee availability for the one or more lessors or lessor agents to retrieve the property.

24. The method of claim 23 further comprising:
querying the one or more lessors or lessor agents about future actions to be taken by the system; and
receiving a response to the query from the one or more lessors or lessor agents and storing the response on the data storage medium.

25. The method of claim 23 further comprising:
confirming an identity of the one or more lessors or lessor agents, prior to providing the one or more lessors or lessor agents with information.

26. The method of claim 20 further comprising:
connecting the lessees with a customer service representative over the communications network.

27. The method of claim 21 further comprising:
leaving a message for the lessees when the system does not receive an affirmative response to the query regarding the identity of the lessees.

28. The method of claim 25 further comprises:
leaving a message for the one or more lessors or lessor agents, when the system does not receive an affirmative response to the query regarding the identity of the one or more lessors or lessor agents.

29. The method of claim 20 further comprising:
receiving a commitment for future remittance for the debt; and
scheduling the future remittance with the lessee.

30. The method of claim 20 further comprising:
receiving a remittance for the debt.

31. The method of claim 20 further comprising:
scheduling a return of the property at a location associated with the one or more lessors or lessor agents.

32. The method of claim 20 further comprising:
scheduling a retrieval of the property by the one or more lessors or lessor agents at a location associated with the lessees.

33. The method of claim 24 further comprising:
offering the one or more lessors or lessor agents the option of collecting remittance toward the debts.

34. The method of claim 24 further comprising:
offering the one or more lessors or lessor agents the option of reporting the retrieval of the property or equipment.

35. The method of claim 20 further comprising:
recording communications over the electronic network between the system and the lessees.

36. The method of claim 24 further comprising:
recording communications over the electronic network between the system and the lessees and between the system and the one or more lessors or lessor agents.

37. The method of claim 36 further comprising:
preparing and transmitting one or more reports regarding communications between the system and the lessees and the system and the one or more lessors and lessor agents.

38. The method of claim 24 further comprising:
connecting the lessees or the one or more lessors or lessor agents with a customer service representative over the communications network.
